(19) United States
(12) Patent Application Publication
(10) Pub. No.: US 2026/0004257 A1
(43) Pub. Date: Jan. 1, 2026

(54) INFORMATION PROCESSING DEVICE, BATTERY DEVICE, AND INFORMATION PROCESSING SYSTEM

(71) Applicant: TOYOTA JIDOSHA KABUSHIKI KAISHA, Toyota-shi (JP)

(72) Inventors: Keisuke ISOMURA, Kariya-shi (JP); Tatsuhiko SASAKI, Toyota-shi (JP); Iwao NITTA, Nagoya-shi (JP); Aya OHKUBO, Nisshin-shi (JP); Sotaro HAYASHI, Okazaki-shi (JP); Masahiro KAGAMI, Nagoya-shi (JP); Hiroshi YAMASAKI, Nagoya-shi (JP); Makoto MIZUGUCHI, Toyota-shi (JP); Kenta KIMURA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 19/034,634

(22) Filed: Jan. 23, 2025

(30) Foreign Application Priority Data
Jun. 26, 2024 (JP) 2024-103382

(51) Int. Cl. G06Q 10/20

(52) U.S. Cl. CPC G06Q 10/20

(57) ABSTRACT

A control unit of an information processing device determines whether registration information for tracking the location of a battery mounted on a vehicle is registered in a predetermined management device. When the registration information is registered, the control unit of the information processing device outputs data that permits removal of the battery from the vehicle.

### CROSS-REFERENCE TO RELATED APPLICATION

This application claims priority to Japanese Patent Application No. 2024-103382 filed on Jun. 26, 2024, incorporated herein by reference in its entirety.

### BACKGROUND

### 1. Technical Field

The present disclosure relates to information processing devices, battery devices, and information processing systems.

### 2. Description of Related Art

Japanese Unexamined Patent Application Publication No. 2021-191159 (JP 2021-191159 A) discloses a management device that manages a secondary battery mounted on a vehicle. The management device disclosed in JP 2021-191159 A stores management information on each of a plurality of vehicles. The management information indicates, for each of the vehicles, whether the vehicle is a target vehicle whose battery replacement time is managed. The management device estimates the degree of degradation of a secondary battery mounted on the target vehicle by using history information indicating the usage history of the secondary battery mounted on the target vehicle. When the estimated degree of degradation of the secondary battery reaches a predetermined threshold value, the management device sends a notification signal notifying that it is time for battery replacement for the target vehicle.

### SUMMARY

An object of the present disclosure is to provide a technique that allows appropriate tracking of a battery of a vehicle.

An information processing device according to a first aspect of the present disclosure includes a control unit. The control unit is configured to execute determining whether registration information for tracking a location of a battery mounted on a vehicle is registered in a predetermined management device, and when the registration information is registered, outputting data that permits removal of the battery from the vehicle.

A battery device according to a second aspect of the present disclosure is a battery device mounted on a vehicle. The battery device includes a control unit. The control unit is configured to
determine whether registration information for tracking a location of the battery device is registered in a predetermined management device, and
when the registration information is registered, output an unlock permission signal to a lock mechanism between the battery device and the vehicle.

An information processing system according to a third aspect of the present disclosure is
an information processing system including an information management device and a battery management device.

The information management device is configured to
receive registration of registration information for tracking a location of a battery mounted on a vehicle.

The battery management device is configured to
determine whether the registration information is registered in the information management device, and
when the registration information is registered, output data that permits removal of the battery from the vehicle.

The present disclosure allows appropriate tracking of a battery of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a lock and unlock management system according to an embodiment;

FIG. 2 is a block diagram schematically illustrating an example of a functional configuration of each of a battery, an information server, and a management server according to the embodiment;

FIG. 3 is a diagram illustrating an example of a table configuration of registration information held in a registration information database;

FIG. 4 is a diagram illustrating an example of a table configuration of registered battery information held in a registered battery information database;

FIG. 5 is a sequence diagram illustrating a flow of information processing in the lock and unlock management system; and

FIG. 6 is a flowchart of a determination process performed by a control unit of the management server.

### DETAILED DESCRIPTION OF EMBODIMENTS

The location of the battery removed from the vehicle may be unknown. In this case, when a battery whose source is unknown is traded and a failure or the like occurs, it may be difficult to identify the cause. In addition, if the battery is not properly used or discarded at a location after the battery is removed, there is a possibility that the battery may be damaged.

Therefore, the control unit of the information processing device according to the first aspect of the present disclosure determines whether the registration information for tracking the location of the battery mounted on the vehicle is registered in the predetermined management device. When the registration information is registered, the control unit of the information processing device outputs data that permits removal of the battery from the vehicle.

As described above, the information processing device can remove the battery from the vehicle when the registration information is registered. This can reduce the possibility of the battery being removed in a situation where the location of the battery cannot be tracked. As a result, it is possible to appropriately track the battery of the vehicle.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### EMBODIMENT

### System Overview

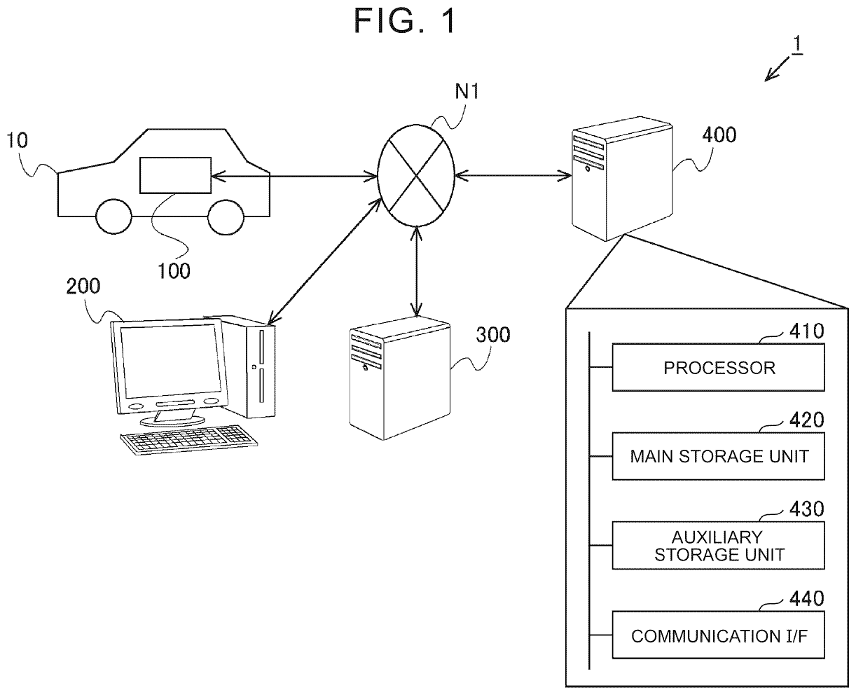

The lock and unlock management system 1 according to the present embodiment will be described with reference to FIG. 1. FIG. 1 is a diagram illustrating a schematic configuration of a locking and unlock management system 1 according to the present embodiment. The lock and unlock management system 1 includes a battery 100, a business operator terminal 200, an information server 300, and a management server 400. In the lock and unlock management system 1, the battery 100, the business operator terminal 200, the information server 300, and the management server 400 are connected to each other by a network N1. The network N1 may be, for example, a worldwide public communication network such as the Internet or the like, and a WAN (Wide Area Network) or a telecommunications network such as a cellular network.

### Battery

The battery 100 is a battery that can be attached to the vehicle 10. The battery 100 is a battery for driving the vehicle 10. The battery 100 may be, for example, an auxiliary battery of the vehicle 10. After the battery 100 is removed from the vehicle 10, it can be re-installed in another vehicle or reused for use as a storage battery for home use.

When the battery 100 is mounted on the vehicle 10, it is locked by a locking mechanism with respect to the vehicle 10. That is, the battery 100 cannot be removed from the vehicle 10 unless the locked state with the vehicle 10 is released. In the present embodiment, the battery 100 outputs an unlock permission signal to the lock mechanism to actuate an actuator in the lock mechanism, thereby releasing the locked state with respect to the vehicle 10.

### Business Operator Terminal

The business operator terminal 200 is a terminal used by a business operator who removes a battery (hereinafter, may be simply referred to as “business operator”). The business operator terminal 200 receives input of information (hereinafter, may be referred to as “registration information”) for tracking the vehicle 10 from the business operator at the timing when the battery 100 is removed from the vehicle 10. The registration information is received by the business operator inputting the registration information to the business operator terminal 200. Here, the business operator inputs an identifier (battery ID) for identifying the battery 100, a date of removal of the battery 100, a former owner of the battery 100, a purpose of removal, a transferee of the removed battery 100, and the like as registration information to the business operator terminal 200. The business operator terminal 200 sends the registration information to the information server 300 via the network N1.

### Information Server

The information server 300 is a server device that manages registration information. The information server 300 receives the registration information from the business operator terminal 200 via the network N1. The information server 300 registers the registration information received from the business operator terminal 200.

### Management Server

The management server 400 is a server device that manages removal of a battery. Here, when the battery 100 is removed from the vehicle 10, the location of the battery 100 may be unknown. In this case, when a battery whose source is unknown is traded and a failure or the like occurs, it may be difficult to identify the cause. In addition, if the battery is not properly used or discarded at the location of the battery, there is a possibility that the battery may be damaged.

Therefore, the management server 400 permits removal of the battery 100 from the vehicle 10 when the registration information about the battery 100 is registered. Specifically, when the registration information on the battery 100 is registered, the management server 400 sends the unlock permission information to the battery 100 via the network N1. The unlock permission information is information that permits unlocking of the lock mechanism between the battery 100 and the vehicle 10. That is, the unlock permission information is information that permits the battery 100 to output the unlock permission signal to the lock mechanism between the battery 100 and the vehicle 10. On the other hand, when the registration information about the battery 100 is not registered, the management server 400 prohibits the removal of the battery 100 from the vehicle 10. A method for the management server 400 to determine whether the registration information for the battery 100 is registered and a method for permitting or prohibiting removal of the battery 100 from the vehicle 10 will be described in detail later.

The management server 400 includes a computer having a processor 410, a main storage unit 420, an auxiliary storage unit 430, and a communication interface (communication I/F) 440. The processor 410 is, for example, CPU (Central Processing Unit) or DSP (Digital Signal Processor). The main storage unit 420 is, for example, random access memory (RAM). The auxiliary storage unit 430 is, for example, read only memory (ROM). The auxiliary storage unit 430 is, for example, an HDD (Hard Disk Drive), a CD-ROM, DVD disc, or a disc recording medium such as a Blu-ray disc. The auxiliary storage unit 430 may be a removable medium (portable storage medium). Examples of the removable medium include USB memories and SD cards. The communication I/F 440 is, for example, a LAN (Local Area Network) interface board or wireless communication circuitry for wireless communication.

In the management server 400, an operating system (OS), various programs, various information tables, and the like are stored in the auxiliary storage unit 430. In the management server 400, the processor 410 loads the program stored in the auxiliary storage unit 430 into the main storage unit 420 and executes the program, thereby realizing various functions as described later. However, part or all of the functions of the management server 400 may be realized by hardware circuitry such as ASIC or FPGA. Note that the management server 400 is not necessarily realized by a single physical configuration, and may be constituted by a plurality of computers that cooperate with each other. In addition, the battery 100, the business operator terminal 200, and the information server 300 are configured to include a computer, similarly to the management server 400.

### Functional Configuration

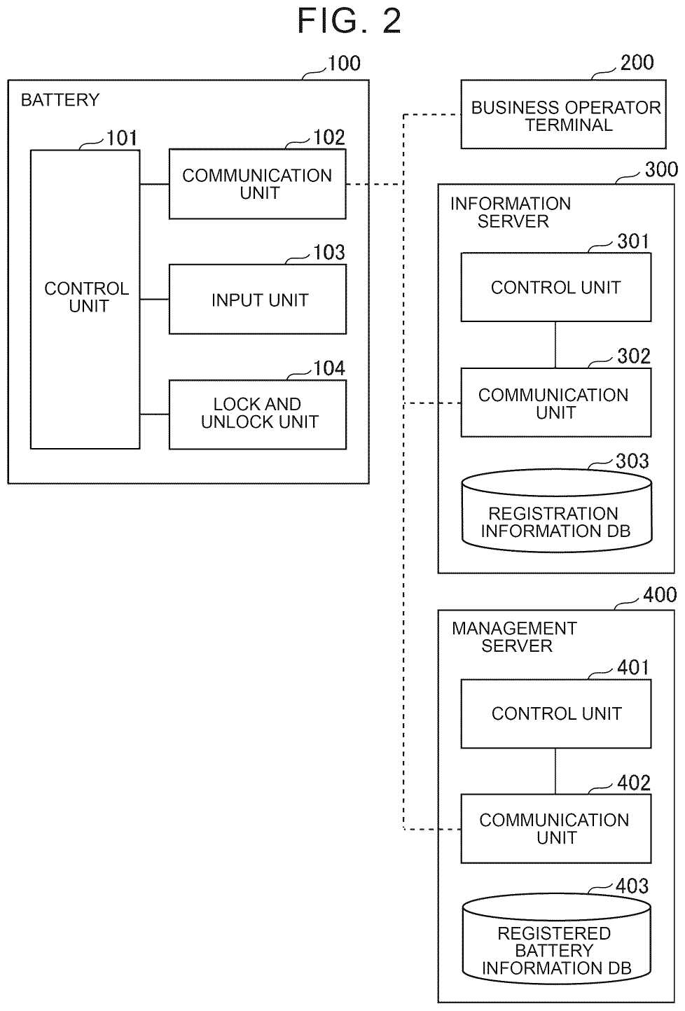

Next, the functional configurations of the battery 100, the information server 300, and the management server 400 constituting the lock and unlock management system 1 according to the present embodiment will be described with reference to FIGS. 2 to 4. FIG. 2 is a block diagram schematically illustrating an example of a functional configuration of each of the battery 100, the information server 300, and the management server 400 according to the present embodiment.

### Battery 100

The battery 100 includes a control unit 101, a communication unit 102, an input unit 103, and a lock and unlock unit 104. The control unit 101 has a function to perform arithmetic processing for controlling the battery 100. The control unit 101 can be realized by a processor in the battery 100. The communication unit 102 has a function to connect the battery 100 to the network N1. The communication unit 102 can be realized by a communication I/F in the battery 100.

The input unit 103 has a function to allow a user of the vehicle 10 (the battery 100) to input various information to the battery 100. The input unit 103 can be realized by a touch panel or the like of the battery 100. The control unit 101 receives an input instructing removal of the battery 100 from the vehicle 10 via the input unit 103. For example, the business operator inputs an instruction to the input unit 103 to remove the battery 100 from the vehicle 10. At this time, the control unit 101 sends the unlock request information to the management server 400 via the communication unit 102.

The lock and unlock unit 104 has a function to control a state of locking and unlocking between the battery 100 and the vehicle 10. The lock and unlock unit 104 can be realized by a locking mechanism between the battery 100 and the vehicle 10. The lock mechanism between the battery 100 and the vehicle 10 is provided on the side of the battery 100. The lock mechanism may be provided on the vehicle 10 side. In this case, the lock and unlock unit 104 is electrically connected to the lock mechanism on the vehicle 10 side. When the unlock permission information is received from the management server 400 as a response to the unlock request information, the control unit 101 outputs an unlock permission signal to the lock and unlock unit 104. When receiving the unlock permission signal from the control unit 101, the lock and unlock unit 104 releases the lock between the battery 100 and the vehicle 10. Specifically, the lock and unlock unit 104 causes the lock mechanism in the locked state to perform an unlock operation by sending an unlock permission signal to the actuator in the lock mechanism.

### Information Server 300

The information server 300 includes a control unit 301, a communication unit 302, and a registration information database 303 (registration information DB 303). The control unit 301 has a function to perform arithmetic processing for controlling the information server 300. The control unit 301 can be realized by a processor in the information server 300. The communication unit 302 has a function to connect the information server 300 to the network N1. The communication unit 302 can be realized by a communication I/F in the information server 300.

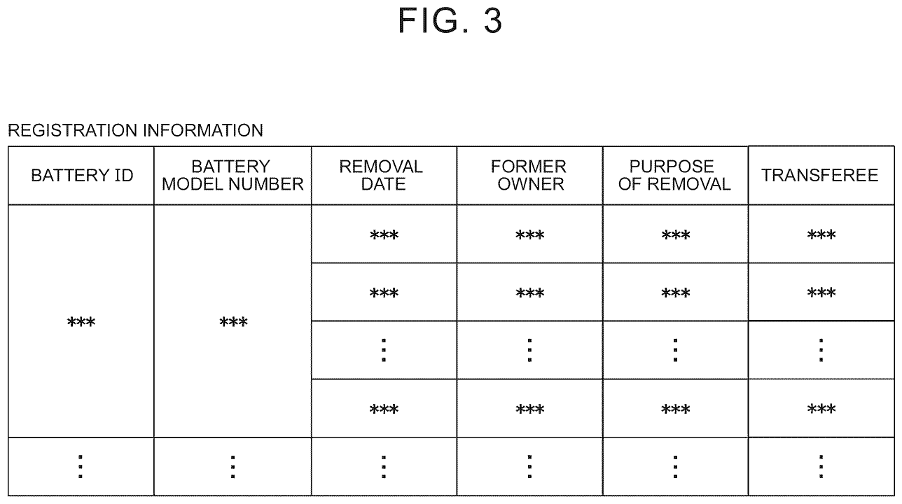

The control unit 301 receives the registration information from the business operator terminal 200 by the communication unit 302. The control unit 301 stores the received registration information in the registration information DB 303. FIG. 3 is a diagram illustrating an exemplary table configuration of registration information held in the registration information DB 303. The registration information DB 303 can be realized by the auxiliary storage unit in the information server 300. As shown in FIG. 3, the registration information includes a battery ID field, a battery model number field, a removal date field, a former owner field, a purpose-of-removal field, and a transferee field.

In the battery ID field, an identifier (battery ID) for specifying a battery is stored. In the battery model number field, information indicating the model number of the battery of the corresponding battery ID is stored. The removal date field stores information indicating a date on which the battery of the corresponding battery ID was removed. The former owner field stores information indicating the original owner (former owner) of the battery of the corresponding battery ID. The purpose-of-removal field stores information indicating a purpose for which the battery of the corresponding battery ID was removed. In the transferee field, information indicating a transferee of the removed battery is stored. The information on the battery ID, the battery model number, the removal date, the former owner, the purpose of removal, and the transferee is information included in the registration information received from the business operator terminal 200.

Here, the battery may be removed from the vehicle a plurality of times. In this case, the information is stored in the removal date field, the former owner field, the purpose-of-removal field, and the transferee field for the number of times the removal is performed. The registration information may include information indicating an operator (business operator) who has removed the battery. The control unit 301 can track the location of the battery (former owner, removal business operator, and transferee after removal) by referring to the registration information held in the registration information DB 303.

When the registration information about the battery 100 is stored in the registration information DB 303, the control unit 301 sends the registration completion information about the battery 100 to the management server 400 via the communication unit 302. Here, the registration completion information about the battery 100 is information including the battery ID of the battery 100 and the registration completion date and time of the registration information about the battery 100.

### Management Server 400

The management server 400 includes a control unit 401, a communication unit 402, and a registered battery information database 403 (registered battery information DB 403). The control unit 401 has a function to perform arithmetic processing for controlling the management server 400. The communication unit 402 has a function to connect the management server 400 to the network N1. The communication unit 402 can be realized by a communication I/F 440 in the management server 400.

The control unit 401 receives the registration completion information from the information server 300 via the communication unit 402. The control unit 401 updates the registered battery information held in the registered battery information DB 403 in accordance with the received registration completion information. Here, the registered battery information DB 403 can be realized by the auxiliary storage unit 430 in the management server 400. The registered battery information is information indicating a battery that is permitted to be removed from the vehicle because the registration of the registration information is completed.

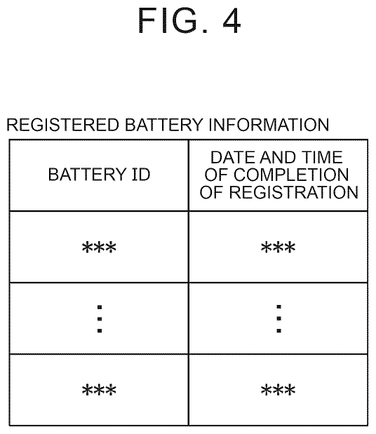

FIG. 4 is a diagram illustrating an exemplary table configuration of registered battery information held in the registered battery information DB 403. As shown in FIG. 4, the registered battery information includes a battery ID field and a registration completion date and time field. In the battery ID field, an identifier (battery ID) identifying the battery whose registration information is registered is stored. In the registration completion date and time field, information indicating the date and time when the registration of the registration information for the battery of the corresponding battery ID is completed is stored. The control unit 401 acquires the battery ID and the registration completion date and time included in the registration completion information, and stores them in the battery ID field and the registration completion date and time field.

By referring to the registered battery information held in the registered battery information DB 403, the control unit 401 can determine whether the battery is a battery for which registration of registration information has been completed without accessing the information server 300. As a result, the control unit 401 can determine whether the battery is a battery in which the registration of the registration information is completed by accessing the information server 300 and determining whether the registration of the registration information is completed. In addition, even when the control unit 401 cannot access the information server 300, it is possible to determine whether the battery is a battery for which registration of registration information is completed. When the information server 300 is an accessible server, the control unit 401 may refer to the registration information DB 303 in the information server 300 and determine whether the registration information of the battery 100 is registered.

The control unit 401 receives the unlock request information from the battery 100 via the communication unit 402. Here, the unlock request information includes a battery ID of the battery 100. The control unit 401 refers to the unlock request information, and performs a process of determining whether the registration information of the battery of the battery 100 is registered (hereinafter, may be referred to as “determination process”). Specifically, the control unit 401 refers to the registered battery information held in the registered battery information DB 403, and determines whether the battery ID of the battery 100 included in the unlock request information is registered.

When the battery ID of the battery 100 is registered in the registered battery information, the registration information on the battery 100 is registered in the information server 300. Therefore, when the battery ID of the battery 100 is registered in the registered battery information, the control unit 401 permits removal of the battery 100 from the vehicle 10. In this case, the control unit 401 sends the unlock permission information to the battery 100 via the communication unit 402. This allows the battery 100 to be removed from the vehicle 10.

When the battery ID of the battery 100 is not registered in the registered battery information, the registration information of the battery 100 is not registered in the information server 300. Therefore, when the battery ID of the battery 100 is not registered in the registered battery information, the control unit 401 prohibits the battery 100 from being removed from the vehicle 10. At this time, the control unit 401 prohibits the removal of the battery 100 from the vehicle 10 by not sending the unlock permission information. Further, the control unit 401 may prohibit the removal of the battery 100 from the vehicle 10 by sending the unlock prohibition information indicating prohibition of unlocking to the battery 100.

### Flow of Information Processing

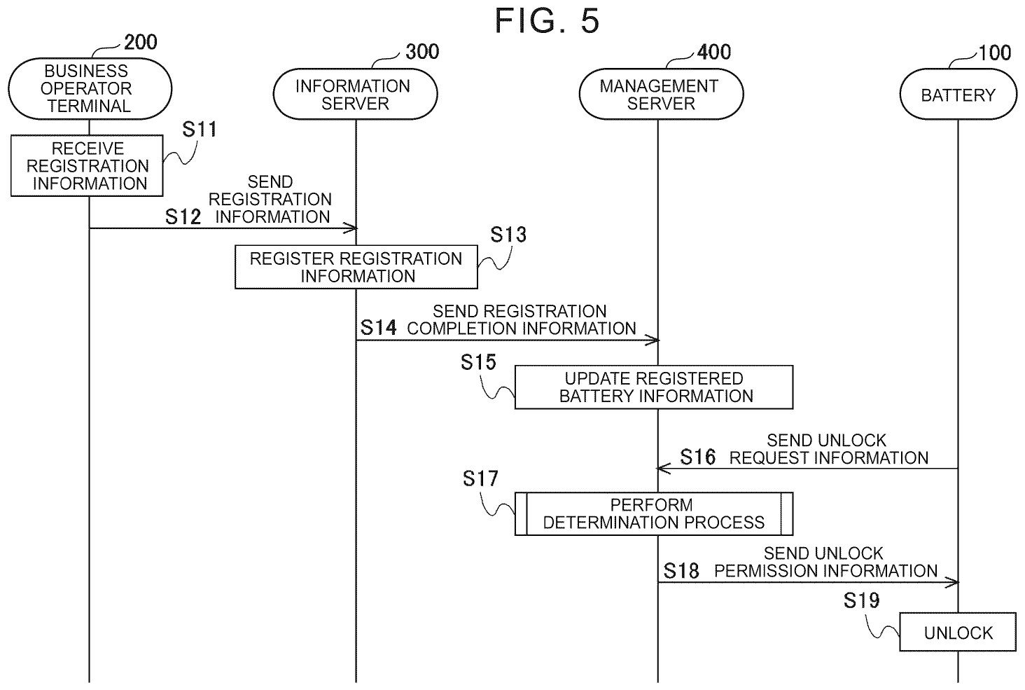

The flow of information processing in the lock and unlock management system 1 will be described with reference to FIG. 5. FIG. 5 is a sequence diagram illustrating the flow of information processing in the lock and unlock management system 1. FIG. 5 shows a flow of information processing when the business operator registers registration information about the battery 100. Each process performed by the battery 100, the business operator terminal 200, the information server 300, and the management server 400 is performed by the control unit 101 of the battery 100, the control unit of the business operator terminal 200, the control unit 301 of the information server 300, and the control unit 401 of the management server 400.

In the lock and unlock management system 1, the business operator terminal 200 receives input of the registration information by the business operator (S11). When input of the registration information by the business operator is completed, the business operator terminal 200 sends the registration information to the information server 300 (S12). Next, the information server 300 registers the registration information received from the business operator terminal 200 (S13). When the registration of the registration information is completed, the information server 300 sends the registration completion information to the management server 400 (S14). When receiving the registration completion information from the information server 300, the management server 400 updates the registration battery information (S15).

After that, the battery 100 sends the unlock request information to the management server 400 (S16). Then, the management server 400 performs a determination process (S17). In the example shown in FIG. 5, since the registration information about the battery 100 has been registered, the management server 400 sends the unlock permission information to the battery 100 (S18). Upon receiving the unlock permission information, the battery 100 releases the lock between the battery 100 and the vehicle 10 by outputting an unlock permission signal to the lock mechanism (S19).

### Determination Process

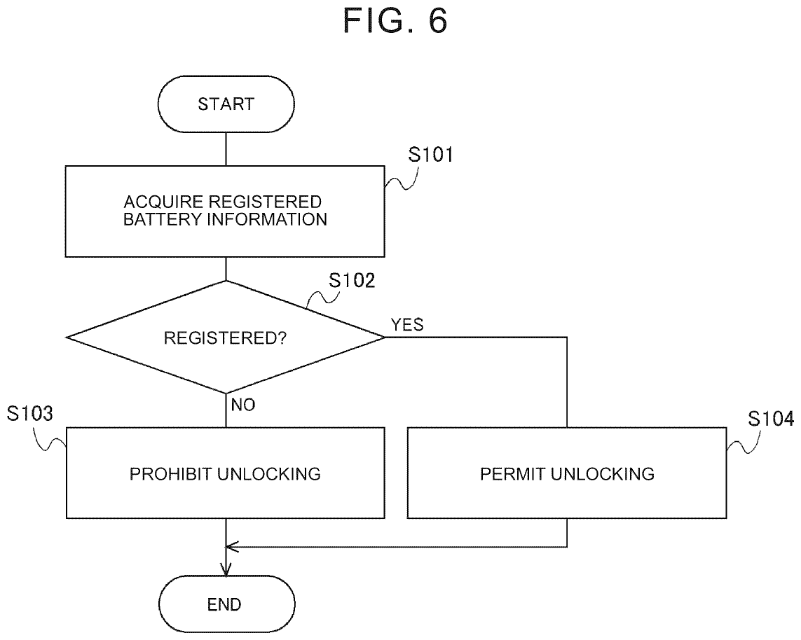

Next, a determination process that is performed by the control unit 401 in the management server 400 in the lock and unlock management system 1 will be described with reference to FIG. 6. FIG. 6 is a flowchart of the determination process that is performed by the control unit 401 of the management server 400. As shown in FIG. 5, the determination process is started when unlock request information is received from the battery 100.

In the determination process, first, in S101, the registered battery information is acquired from the registered battery information DB 403. Next, in S102, it is determined whether the battery ID of the battery 100 is registered in the acquired registered battery information. When NO in S102, the registration information is not registered in the information server 300, and therefore, if the battery 100 is removed from the vehicle 10, the location of the battery 100 may become unknown. Therefore, when NO in S102, unlocking is prohibited in S103. Then, the determination process is ended.

On the other hand, when YES in S102, the registration information is registered in the information server 300. Then, unlocking is permitted in S104, and the determination process is ended. As a result, the unlock permission information is sent to the battery 100 in the process of S18 shown in FIG. 5, and the battery 100 and the vehicle 10 are unlocked.

As described above, in the lock and unlock management system 1, when the registration information about the battery 100 is registered in the information server 300, the battery 100 can be removed from the vehicle 10. On the other hand, when the registration information about the battery 100 is not registered, removal of the battery 100 from the vehicle 10 is prohibited. This can reduce the possibility of the battery 100 being removed from the vehicle 10 in a situation where the location of the battery 100 cannot be tracked. As a result, it is possible to appropriately track the battery 100.

### First Modification

In the present embodiment, the management server 400 determines whether the registration information for the battery 100 is registered, and sends the unlock permission information. Accordingly, the battery 100 that has received the unlock permission information outputs the unlock permission signal, thereby releasing the locked state with respect to the vehicle 10.

On the other hand, in the present modification, the battery 100 determines whether the registration information on the battery 100 is registered, and outputs an unlock permission signal to the lock mechanism. When the registration completion information is received from the information server 300, the battery 100 can recognize that the registration information is registered. Therefore, when it is determined that the registration completion information is received from the information server 300, the battery 100 permits the unlock permission signal to be output to the lock mechanism when an input for instructing unlocking is received. When determining that the registration completion information is not received from the information server 300, the battery 100 prohibits the output of the unlock permission signal. Even in this manner, it is possible to appropriately track the battery 100.

### Second Modification

In the present embodiment, the battery 100 outputs an unlock permission signal to the lock mechanism between the battery 100 and the vehicle 10. However, the electronic control unit (ECU) of the vehicle 10 may output an unlock permission signal to the lock mechanism between the battery 100 and the vehicle 10. In this case, ECU of the vehicle 10 is connectable to the network N1, and outputs an unlock permission signal to the lock mechanism when the unlock permission information is received from the management server 400. Note that ECU of the vehicle 10 may output the unlock permission signal when the registration completion information is received from the information server 300. Even in this manner, it is possible to appropriately track the battery 100.

### Other Embodiments

The above embodiments are merely illustrative, and the present disclosure can be implemented with appropriate modifications within a range not departing from the scope thereof. In addition, the processes and means described in the present disclosure can be freely combined and implemented as long as there is no technical inconsistency.

Further, the processes described as being performed by one device may be shared and performed by a plurality of devices. Alternatively, the processes described as being performed by different devices may be performed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Non-transitory computer-readable storage media include, for example, any type of disk, such as a magnetic disk (such as a floppy disk or a hard disk drive (HDD)), an optical disk (such as a CD-ROM, DVD disk or a Blu-ray disk). Non-transitory computer-readable storage media also include any types of media suitable for storing electronic instructions, such as, for example, read only memory (ROM), random access memory (RAM), EPROM, EEPROM, magnetic cards, flash memory, or optical cards.

What is claimed is:

1. An information processing device comprising a control unit configured to execute
determining whether registration information for tracking a location of a battery mounted on a vehicle is registered in a predetermined management device, and
when the registration information is registered, outputting data that permits removal of the battery from the vehicle.

2. The information processing device according to claim 1, wherein the outputting the data that permits the removal includes outputting an unlock permission signal for a lock mechanism between the battery and the vehicle.

3. The information processing device according to claim 1, wherein the registration information is information indicating at least one of the following: an owner of the battery, a business operator who removes the battery, and a transferee of the battery after the removal.

4. A battery device mounted on a vehicle, the battery device comprising a control unit configured to
determine whether registration information for tracking a location of the battery device is registered in a predetermined management device, and
when the registration information is registered, output an unlock permission signal to a lock mechanism between the battery device and the vehicle.

5. An information processing system including an information management device and a battery management device, wherein:
the information management device is configured to receive registration of registration information for tracking a location of a battery mounted on a vehicle; and
the battery management device is configured to
determine whether the registration information is registered in the information management device, and
when the registration information is registered, output data that permits removal of the battery from the vehicle.
